(19) United States
(12) Patent Application Publication
(10) Pub. No.: US 2010/0146187 A1
(43) Pub. Date: Jun. 10, 2010

(54) ENDURANCE MANAGEMENT TECHNIQUE

(76) Inventors: Knut S. Grimsrud, Forest Grove, OR (US); Richard L. Coulson, Portland, OR (US)

Correspondence Address: Rita M. Wisor;c/o Intellevate, LLC, P.O. Box 52050, Minneapolis, MN, 55402, US

(21) Appl. No.: 12/329,079

(22) Filed: Dec. 5, 2008

(51) Int. Cl. G06F 12/00; G06F 12/02

(52) U.S. Cl. 711/103; 711/154; 711/E12.001; 711/E12.008

(57) ABSTRACT

According to embodiments of the present invention, endurance management techniques are disclosures. Adherence to endurance and data retention ratings are ensured by managing write accesses to a memory device.

A portion of the disclosure of this patent document contains material that is subject to copyright protection. The copyright owner has no objection to the reproduction by anyone of the patent disclosure, as it appears in the Patent and Trademark office patent files or records, but otherwise reserves all copyright rights whatsoever.

### BACKGROUND

### Description of the Related Art

Most things wear out after a period of usage. In the electronics industry, electronic components are not guaranteed to last forever. NAND Flash memory is one such type of component that wears out with usage. That is, the more erase cycles (which can be related to the number of write cycles) to a flash device, the less amount of time the memory retains valid data.

Electronic components such as NAND Flash memory may be rated according to specific endurance standards, allowing for standardized component endurance ratings across an industry. FIG. 1 illustrates such an industry standard, the JEDEC (Joint Electron Device Engineering Council) Endurance and Retention Specification that describes the relationship between retention and endurance of rated components. This graph illustrates the expected number of years a flash memory device must retain valid data after a given percent of maximum cycles have been performed on the device. For example, if a device has received 10% or less of its maximum rated write cycles, the device must retain the data for a minimum of 10 years. After receiving 100% of its maximum rated write cycles, the device must retain the data for a minimum of 1 year. By using the JEDEC endurance specification, flash memory devices may be rated according to cycling capability. Devices are rated and marketed according to maximum write cycles that meet the JEDEC endurance specification, for example at 50 k, 100 k or the like maximum write cycles.

Because the maximum cycling capability may be guaranteed by a component manufacturer, techniques may be needed to ensure that each device provide the rated capability, even in pathological or hostile use environments where the applied write intensity exceeds the sustained write endurance capability of the device for its rated life.

### BRIEF DESCRIPTION OF THE DRAWINGS

The present invention may be better understood, and its numerous features and advantages made apparent to those skilled in the art by referencing the accompanying drawings.

FIG. 1 illustrates the JEDEC (Joint Electron Device Engineering Council) Endurance and Retention Specification.

FIG. 2 illustrates a storage device according to an embodiment of the present invention.

FIG. 3 illustrates an allowable cycles graph to reach five years of product life according to an embodiment of the present invention.

FIG. 4 illustrates endurance management behavior of a system according to an embodiment of the present invention.

The use of the same reference symbols in different drawings indicates similar or identical items.

### DESCRIPTION OF THE EMBODIMENT(S)

In the following description, numerous specific details are set forth. However, it is understood that embodiments of the invention may be practiced without these specific details. In other instances, well-known methods, structures and techniques have not been shown in detail in order not to obscure an understanding of this description.

References to “one embodiment,” “an embodiment,” “example embodiment,” “various embodiments,” etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Unless specifically stated otherwise, as apparent from the following discussions, it is appreciated that throughout the specification discussions utilizing terms such as “processing,” “computing,” “calculating,” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data from registers and/or memory to transform that electronic data into other electronic data that may be stored in registers and/or memory. A “computing platform” may comprise one or more processors.

FIG. 2 illustrates a storage device according to an embodiment of the present invention. Storage device 200 includes a host interface 202 with a host bus 204 for sending and receiving communications from a host. Such communications may include a request to write data to or read data from a memory array 206. A controller 208 manages accesses to memory array 206. Further access requests may be received from memory management functionality 210, which are also managed by controller 208.

Memory array 206 may include an array of flash components or cells, including NAND flash memory. Other memory types may be used, such as DRAM, SRAM, NOR flash memory, phase change memory, polymer memory, and the like.

Memory management functionality 210 may be part of controller 208 or separate functionality within storage device 200. Further, memory management functionality may be software algorithms running on a general purpose or dedicated processing circuitry. Memory management functionality 210 may includes such items as wear leveling functionality, file management systems, and the like.

Storage device 200 may be a solid state disk drive, an MP3 player, a mobile internet device (MID), or any other device that may include a memory array. Storage device 200 may be a stand alone component, or alternatively, packaged as a portion of a larger device. Storage device 200 may include other components, not shown, such as additional I/O interfaces, a processor, a wireless interface, a display interface, and the like.

According to an embodiment of the present invention, controller 208 manages write accesses to memory array 206 such that the memory operates within its rated endurance capability. That is, controller 208 paces write accesses so that the memory devices do not wear out before the rated service life of the product. Controller 208 throttles the volume of write accesses to memory array 206 in a given period of time, such that a total write threshold is not a exceeded, and also a write rate threshold is not exceeded. As such, as the total number of write accesses and/or the rate of write accesses approaches specific threshold(s), the performance may be reduced. Further, the specified threshold(s) may change over time due to the amount of idle time, increased budget over time, amount of budget already used, and other factors.

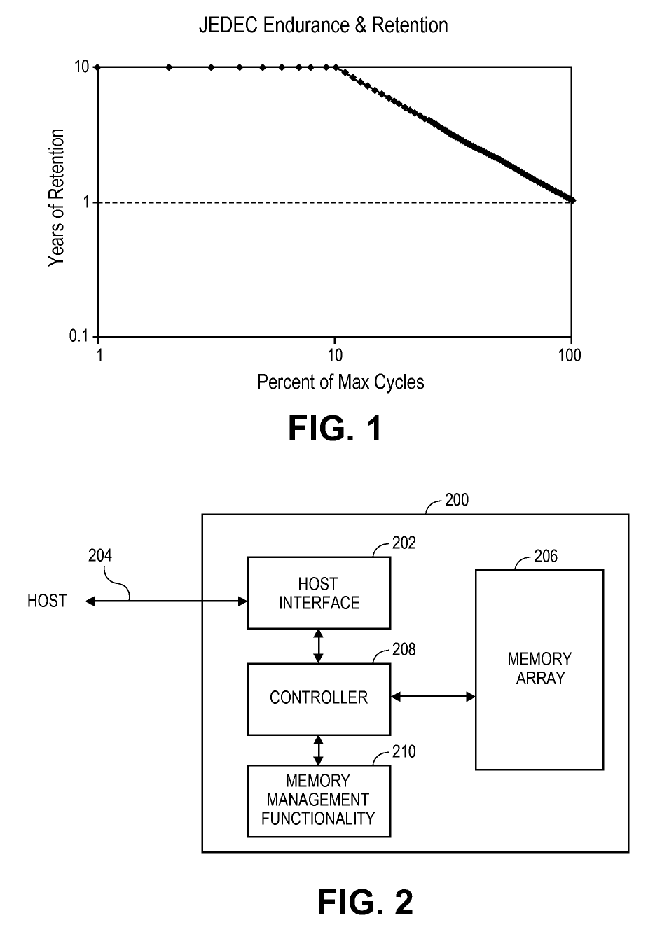

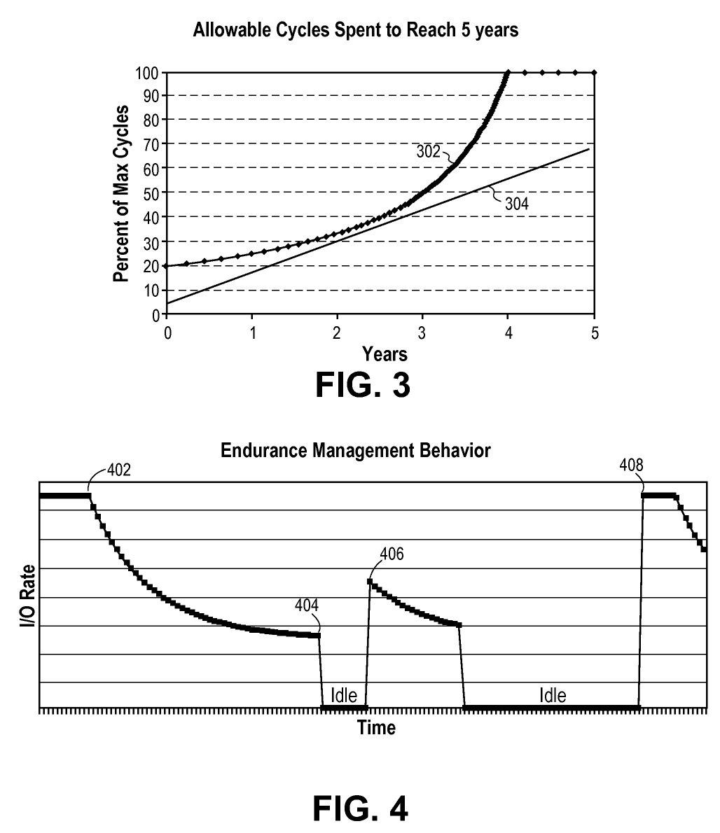

FIG. 3 illustrates an allowable cycles graph to reach five years of product life according to an embodiment of the present invention. As illustrated, curve 302 is the JEDEC Endurance Specification as illustrated in FIG. 1, illustrated as percentage of maximum cycles versus years of data retention. As shown, according to curve 302, at one year, the maximum allowable cycles is approximately 25% of the maximum rated cycles to reach a five year life. In other words, the device will retain data written for an additional four years if the device has received less than approximately 25% of its maximum rated cycles.

According to an embodiment of the present invention, line 304 illustrates a maximum allowable cycles as specified by an embodiment of the present invention. Note that curve 302 reaches 100% maximum cycles at year four, any writes in year four are not guaranteed because the maximum cycles has already been met. This may be unacceptable product performance and not provide an optimum user experience. Thus line 304 is set below the maximum cycles according to the JEDEC endurance specification. Thus, line 304 represents the maximum number of cycles that can be put on a component and ensure that a 5 year life can be delivered regardless of what the user behavior might be. The slope of the managed line, that is, line 304 represents the long-term sustainable daily write rate, for example, 100 GB/day nominally for a 80GB rated device, and the Y intercept of the line represents the amount of data that can be freely written at any rate the user desires prior to endurance management becoming invoked, for example, 40 TB nominally for a 80 GB devices. These two parameters define the endurance envelope within which the product will be maintained.

Controller 208 manages write accesses to memory array 206 such that a total number of cycles remain below line 304 over a five year life of a product. Further, controller 208 manages the rate of write accesses to memory array 206 such that the rate of increase of the total number of writes towards line 304 is controlled. Note that at the beginning of the products life cycle (time=zero years), the percent of maximum cycles is approximately 5%. Further, the percentage increases over the life of the product to a maximum of approximately 68% maximum cycles.

According to an embodiment of the present invention, a basic algorithm that controller 208 may use is shown below (note that some fixed-point considerations are ignored for the sake of clarity):

```
TimerTick1ms:
    If (!(TimerValue%MeteringInterval))
    {
        BankBalance+=Allowance;
        Budget=BankBalance>>TauShift;
    }
Host demand write processing:
    While (HostWriteRequest.Length)
    {
        While(!Budget)
            WaitForTime(1);
        AmountToWrite=min(Budget, HostWriteRequest.Length);
        ReleaseHostWriteToNAND(AmountToWrite);
        Budget−=AmountToWrite;
        Balance−=AmountToWrite;
        HostWriteRequest.Length−=AmountToWrite;
    }
Internal write processing:
    Balance−=InternalWriteRequest.Length;
    ReleaseInternalWriteToNAND(InternalWriteRequest.Length);
```

From the algorithm above, BankBalance is the current total write balance in units of sectors. This value represents, for example, 40 TB (initial value) plus 100 GB/day allowance minus the number of writes performed to date for an 80 GB rated device. The initial value corresponds to the Y intercept of the managed endurance line in FIG. 3. Allowance is the amount of incremental write allowance per metering interval that the system supports. This reflects the long-term sustained daily write accommodation beyond the initial balance, for example, 100 GB/day nominal for an 80 GB rated device. This value corresponds to the slope of the managed endurance line in FIG. 3. Tau is the factor controlling the speed of responsiveness of the system. This is a tiny positive fraction (such as 0.00001). To improve computational efficiency, this parameter is represented as the number of bits to shift right by (for example, the value 5 represents a shift right by 5 bits which is effectively 1/32) which is referred to by the name TauShift. This value is nominally in the range of 20-30 bits depending on the desired system responsiveness rate. IntervalBudget is the number of write credits for a given metering interval. This value is in units of sectors and represents the number of sectors of data that can be written during a given metering interval.

BankBalance, Allowance, and Tau may be factory-settable parameters based on the rating of the memory devices used in the system.

According to an embodiment of the present invention, only host demand writes may be paced by the algorithm and that internal write operations (such as those from memory management functionality 210) may occur at the full internal rate of the device, although they are accounted for in the total BankBalance. Because internal writes are ultimately induced by host demand write activity, internal write rates are managed as a side effect of the demand writes being paced. In an alternative embodiment, both host writes and writes from internal activities such as memory management functionality 210 may be paced.

FIG. 4 illustrates endurance management behavior of a system according to an embodiment of the present invention. As illustrated, controller 208 allows a full I/O rate or a high access rate for a period of time, until rate threshold limits are approached. As illustrated at 402, the performance (illustrated as I/O rate) is decreased over time until the Allowance value or total write threshold is reached at 404. If the system is idle for a period, then the I/O rate re-accumulates and higher rates are delivered at 406 (which also decay if sustained). If the system is idle for a sufficient time (or the I/O rate is modest for a sufficient time), then the supported I/O rate will recover to its full rate again at 408. As such, performance changes over time based on total cycles used, time, and rate of cycle usage.

According to an embodiment of the present invention, in environments where the write intensity is sustained at excessive levels, the device paces the rate of writes in such a way that it keeps the device in a safe cycling envelope through its rated life.

According to an embodiment of the present invention, the use of components that may not support cycling sufficient to enable a device to run at maximum sustained performance for its' entire rated life is enabled, producing less expensive devices that still conform to endurance ratings. Further, warranty liability exposure is limited for environments where a device is used in applications other than its rated use (for example, using a client mobile drive in an enterprise configuration).

The techniques described above may be embodied in a computer-readable medium for configuring a computing system to execute the method. The computer readable media may include, for example and without limitation, any number of the following: magnetic storage media including disk and tape storage media; optical storage media such as compact disk media (e.g., CD-ROM, CD-R, etc.) and digital video disk storage media; holographic memory; nonvolatile memory storage media including semiconductor-based memory units such as FLASH memory, EEPROM, EPROM, ROM; ferromagnetic digital memories; volatile storage media including registers, buffers or caches, main memory, RAM, etc.; and data transmission media including permanent and intermittent computer networks, point-to-point telecommunication equipment, carrier wave transmission media, the Internet, just to name a few. Other new and various types of computer-readable media may be used to store and/or transmit the software modules discussed herein. Computing systems may be found in many forms including but not limited to mainframes, minicomputers, servers, workstations, personal computers, notepads, personal digital assistants, various wireless devices and embedded systems, just to name a few. A typical computing system includes at least one processing unit, associated memory and a number of input/output (I/O) devices. A computing system processes information according to a program and produces resultant output information via I/O devices.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the various configurations may be implemented as a combined structure or component. These and other variations, modifications, additions, and improvements may fall within the scope of the invention as defined in the claims that follow.

What is claimed is:

1. A method comprising:
tracking a magnitude of write cycles accessing a memory;
throttling additional write accesses to the memory when the magnitude of write cycles approaches a total write threshold that changes with time, wherein the throttling produces a gradual decrease in write performance of the memory.

2. The method as recited in claim 1, wherein the total write threshold increases with time.

3. The method as recited in claim 1, wherein the write performance of the memory is controlled based on the magnitude of write cycles and an amount of time the memory is idle.

4. The method as recited in claim 1, further comprising preventing other write accesses to the memory if the magnitude of write cycles reaches the total write threshold.

5. The method as recited in claim 1, wherein the write accesses to the memory that are throttled are write accesses from a host.

6. The method as recited in claim 1, wherein the write accesses to the memory that are throttled are write accesses from memory management functionality.

7. The method as recited in claim 1, wherein the memory is an array of flash cells.

8. An apparatus comprising:
a memory array;
a host interface for receiving access requests to the memory array from a host;
memory management functionality that produces write access requests to the memory array; and
a controller for controlling accesses to the memory array from the host interface and the memory management functionality, the controller configured to:
track a magnitude of write cycles accessing the memory array; and
throttle additional write accesses to the memory array when the magnitude of write cycles approaches a total write threshold that changes with time, wherein throttling additional write accessing produces a gradual decrease in write performance of the memory array.

9. The apparatus as recited in claim 8, wherein the total write threshold increases with time.

10. The apparatus as recited in claim 8, the controller further configured to prevent other write accesses to the memory array if the magnitude of write cycles reaches the total write threshold.

11. The apparatus as recited in claim 8, wherein the write accesses to the memory array that are throttled are from the host interface.

12. The apparatus as recited in claim 8, wherein the write accesses to the memory array that are throttled are from the memory management functionality.

13. The apparatus as recited in claim 8, wherein the write performance of the memory array is controlled based on the magnitude of write cycles and an amount of time the memory array is idle.

14. A system comprising:
a memory array;
a host that generates access requests to the memory array, the host comprising a processor and one or more input/output interfaces;
memory management functionality that produces write access requests to the memory array; and
a controller for controlling accesses to the memory array from the host and the memory management functionality, the controller configured to:
track a magnitude of write cycles accessing the memory array; and
throttle additional write accesses to the memory array when the magnitude of write cycles approaches a total write threshold that changes with time, wherein throttling additional write accessing produces a gradual decrease in write performance of the memory array.

15. The system as recited in claim 14, wherein the total write threshold increases with time.

16. The system as recited in claim 14, the controller further configured to prevent other write accesses to the memory array if the magnitude of write cycles reaches the total write threshold.

17. The system as recited in claim 14, wherein the write accesses to the memory array that are throttled are from the host.

18. The system as recited in claim 14, wherein the write accesses to the memory array that are throttled are from the memory management functionality.

19. The system as recited in claim 14, wherein the write performance of the memory array is controlled based on the magnitude of write cycles and an amount of time the memory array is idle.
